(19) United States
(12) Patent Application Publication
(10) Pub. No.: US 2016/0335542 A1
(43) Pub. Date: Nov. 17, 2016

(54) Method And Apparatus To Perform Native Distributed Analytics Using Metadata Encoded Decision Engine In Real Time

(71) Applicant: DELL SOFTWARE, INC., Round Rock, TX (US)

(72) Inventors: Shree A. Dandekar, Cedar Park, TX (US); Mark W. Davis, Tracy, CA (US)

(73) Assignee: DELL SOFTWARE, INC., Round Rock, TX (US)

(21) Appl. No.: 14/710,083

(22) Filed: May 12, 2015

(51) Int. Cl. G06N 5/02; G06F 13/36

(52) U.S. Cl. CPC G06N 5/02; G06F 13/36

(57) ABSTRACT

A system, method, and computer-readable medium are disclosed for performing distributed analytics using a metadata encoded decision engine. More specifically, the operation of performing distributed analytics combines metadata encoding of input expectations for models with a multi-tier decision engine. In certain embodiments, the multi-tier decision engine provides arbitrary responses to input failures, including data dropping, routing to additional models, signaling, data conditioning, and even updating of the model parameters themselves. The combination of the processing model, the data input validation, and the decision engine improves the operation of a distributed data processing environment which is focused on predictive and reactive analysis of edge processing data.

### BACKGROUND OF THE INVENTION

1. Field of the Invention

The present invention relates to information handling systems. More specifically, embodiments of the invention relate to performing distributed analytics using a metadata encoded decision engine.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to use a plurality of distributed information handling systems to perform distributed data processing. As distributed data processing becomes increasingly important, there is an increasing need for data validation systems that reside logically near the data and processing model. For example, if a sensor system attached to a gateway produces a stream that includes bursts of data with floating point temperatures and locally normalized date-time stamps, a predictive control model that expects a certain type of data input (e.g., Zulu time data inputs) will potentially produce incorrect responses or simply crash. Many technologies are being developed to process large data sets (often referred to as “big data”, and defined as an amount of data that is larger than what can be copied in its entirety from the storage location to another computing device for processing within time limits acceptable for timely operation of an application using the data). While many known analytic solutions, especially those that work with large data sets, focus on solving the scalability challenges associated with managing real-time data feeds, the need for a robust data validation platform can lead to a plurality of challenges.

For example, solving the scalability challenges associated with managing real-time data feeds can lead to increased cost of data management and data validation and/or to complex data integration processes that may require metadata information from the source connections to quickly consume and prepare the data. Additionally, the need for real-time insights can further burden the data ecosystem. Additionally, as new devices enter the distributed data processing ecosystem especially, for example, a classic Internet of Things (IoT) scenario, there is a growing need to quickly connect, identify, and assimilate data streams with minimal disruption to data processing and analytic processes. Additionally, in an IoT scenario, it is important to translate the physical world into a format that can be handled by the distributed data processing infrastructure. In a simple connected home example the application should have access to an information model about rooms, floors, the location of devices and their functions. One challenge is how to constantly use these information models and blend them with lessons learned from operations.

Accordingly, it would be desirable to enable management of some or all of these data and model mismatches to reduce encoding data expectations and out-of-band failures, as well as provide management strategies for handling such cases.

### SUMMARY OF THE INVENTION

A system, method, and computer-readable medium are disclosed for performing distributed analytics using a metadata encoded decision engine. More specifically, the operation of performing distributed analytics combines metadata encoding of input expectations for models with a multi-tier decision engine. In certain embodiments, the multi-tier decision engine provides arbitrary responses to input failures, including data dropping, routing to additional models, signaling, data conditioning, and even updating of the model parameters themselves. The combination of the processing model, the data input validation, and the decision engine improves the operation of a distributed data processing environment which is focused on predictive and reactive analysis of edge processing data.

More specifically, in certain embodiments, the metadata includes a metadata abstraction layer that facilitates the translation of data requirements from the information model to the data processing source. Also, in certain embodiments, performing distributed analytics using a metadata encoded decision engine enhances data processing accuracy in real-time. Also, in certain embodiments, performing distributed analytics using a metadata encoded decision engine dynamically adapts information models used within the distributed data processing environment to the data sources. Also, in certain embodiments, performing distributed analytics using a metadata encoded decision engine includes a self-learning and/or self-aware information model architecture which enables seamless connectivity as well as a data governance compliant data platform. Also in certain embodiments, the distributed data processing environment includes a system to respond to input failures or data routing failures as well as auto selection and routing to an additional information model in real-time. Also, in certain embodiments, performing distributed analytics using a metadata encoded decision engine includes a decision engine that can condition, auto-update, train the information models in real-time. Also in certain embodiments, performing distributed analytics using a metadata encoded decision engine is incorporated into an IoT data architecture to alleviate the issue of establishing industry standards around data connectivity with legacy and new sources of data.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a simplified block diagram showing an implementation of a distributed data processing environment.

FIG. 3 shows a flow chart of the operation of a distributed analytics system.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

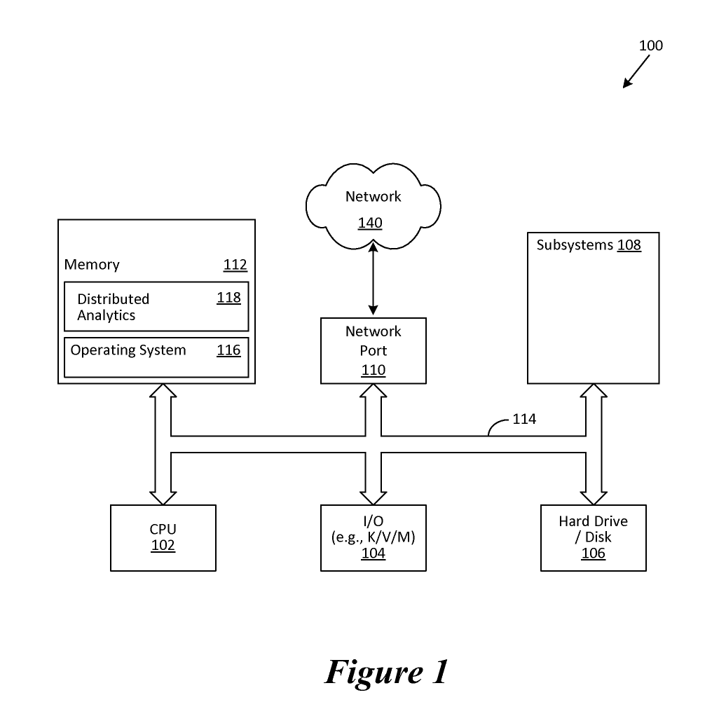

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a distributed analytics module 118.

The distributed analytics module 118 performs distributed analytics using a metadata encoded decision engine. More specifically, the distributed analytics module 118 performs distributed analytics in combination with metadata encoding of input expectations for models with a multi-tier decision engine. In certain embodiments, the multi-tier decision engine provides responses to input failures, including data dropping, routing to additional models, signaling, data conditioning, and even updating of the model parameters themselves. The combination of the processing model, the data input validation, and the decision engine improves the operation of a distributed data processing environment which is focused on predictive and reactive analysis of edge processing data.

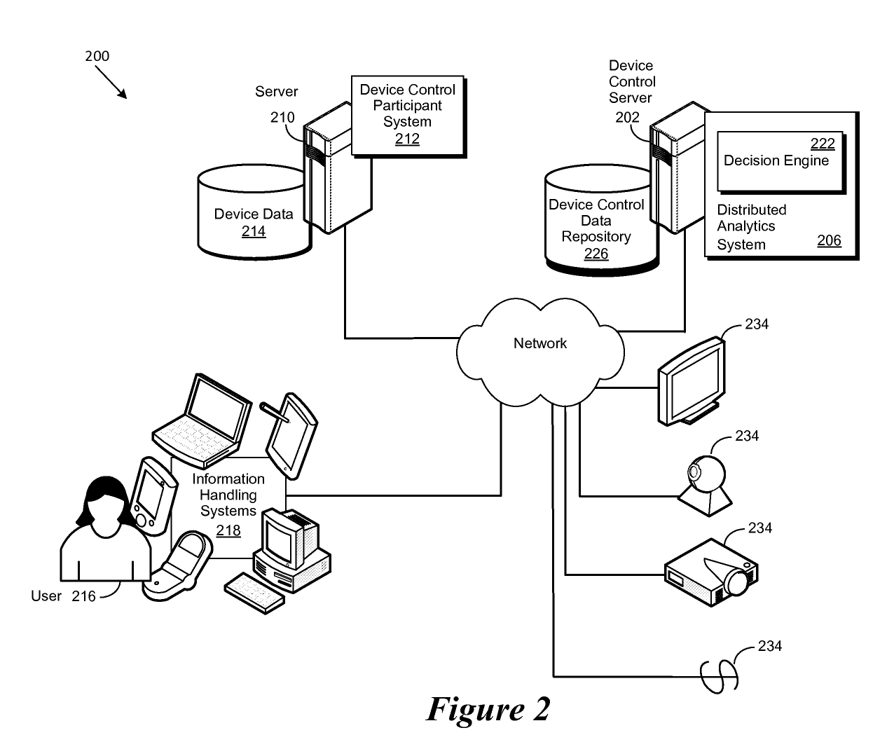

Referring to FIG. 2, a simplified block diagram showing an implementation of a distributed data processing environment 200 in accordance with an embodiment of the invention is shown. The distributed data processing environment 200 includes a device control server 202 which includes a distributed analytics system 206. In certain embodiments, the device control system 206 comprises some or all of the distributed analytics module 118. In certain of these embodiments, the device control system 206 comprises a decision engine 222.

In certain embodiments, a user 216 uses an information handling system 218 to access the device control server 202, either directly or via a device control participant system 212, which is implemented on a server 210 and may access device data 214. As used herein, an information handling system 218 may comprise a personal computer, a laptop computer, or a tablet computer operable to exchange data between the user 216 and the server 210 over a connection to network 140. The information handling system 218 may also comprise a personal digital assistant (PDA), a mobile telephone, or any other suitable device operable to display a user interface (UI) 220 and likewise operable to establish a connection with network 140. In various embodiments, the information handling system 218 is likewise operable to establish a session over the network 140 with the distributed analytics system 206.

In certain embodiments, device control operations are performed by the device control system 206 to control devices (such as a device 234). In certain embodiments, the information handling system 218 may also be considered a device on which device control operations are performed. In certain embodiments, some or all of the devices 234 (as well as the information handling system 218) may be included within a distributed data processing ecosystem which conforms to an Internet of Things (IoT) environment which are controlled by the device control system 206.

More specifically, in certain embodiments, the decision engine 222 includes a metadata encoded decision engine where the metadata includes a metadata abstraction layer that facilitates the translation of data requirements from the information model to the data processing source. Also, in certain embodiments, the device control system 206 performs distributed analytics using a metadata encoded decision engine that enhances data processing accuracy in real-time. Also, in certain embodiments, performing distributed analytics using a metadata encoded decision engine dynamically adapts information models using the distributed data processing environment to the data sources. Also, in certain embodiments, performing distributed analytics using a metadata encoded decision engine includes a self-learning and/or self-aware information model architecture which enables seamless connectivity as well as a data governance compliant data platform. Self-learning and self-awareness is implemented by a combination of a data model that describes the optimal functioning and processing of the data in combination with an optimization system that can vary analytics parameters or models to evaluate whether the set of variations result in improvements of the data processing results. The improved parameter set is then stored for future application to similar data sets. In one embodiment, the optimization operation may be a machine learning model like Support Vector Machines (SVM), K Nearest Neighbors (KNN), Naïve Bayes optimization, or related approaches. In another embodiment, the optimization may be performed by generalized linear regression over the model parameters.

Also in certain embodiments, the distributed data processing environment 200 includes a system to respond to input failures or data routing failures as well as auto selection and routing to an additional information model in real-time. Also, in certain embodiments, performing distributed analytics using a metadata encoded decision engine includes a decision engine that can condition, auto-update, and train the information models in real-time. Also in certain embodiments, performing distributed analytics using a metadata encoded decision engine is incorporated into an IoT data architecture. Doing so alleviates a need to establish industry standards around data connectivity with legacy and new sources of data.

Also, in certain embodiments, the device control server 202 includes a content mining platform and as well as an integration platform. Within the content mining platform is a framework for distributed storage and distributed processing of very large data sets (i.e., big data) on computer clusters such as the Hadoop open source framework. This framework is, among other things, responsible for the consumption of data from the external sources. In the present application, a semantic engine communicates with the framework for distributed storage and distributed processing. The semantic engine captures metadata from the data source (e.g., a device 236).

The metadata is used to alert the decision engine 222 on the appropriate information model to execute. In certain embodiments, the decision engine 222 resides within an integration platform. Such an integration platform provides a light weight architecture and an ability to connect any data source. Thus it is advantageous to include a decision engine 222 within such an integration platform.

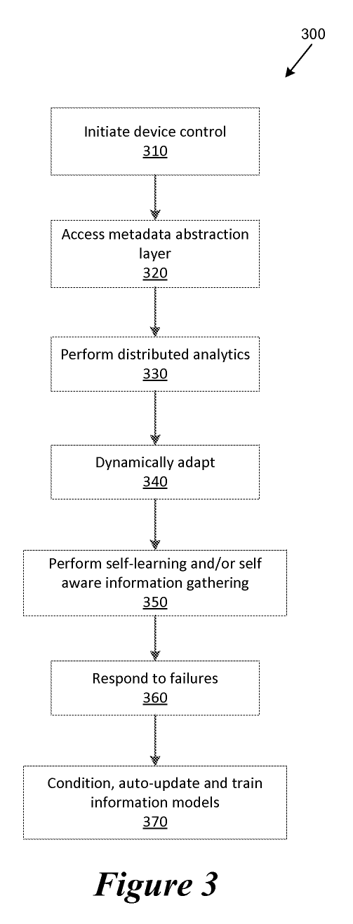

Referring to FIG. 3, a flow chart of the operation of a distributed analytics system is shown. More specifically, device control operations are initiated at step 310 by the device control system 206 to control devices (such as a device 234). Next, at step 320, a metadata abstraction layer is accessed to facilitate translation of data requirements from the information model of device to that data processing model of the device control server 202. Next, at step 330, the device control system 206 performs distributed analytics using the metadata encoded decision engine 222, such distributed analytics enhancing data processing accuracy in real-time. Next, at step 340, the device control system dynamically adapts to the information models of a plurality of devices using the distributed data processing environment to the data sources. Next, at step 350 the device control system 206 performs a self-learning and/or self-aware information gathering operation using a plurality of data operation models and optimization operations. The accuracy of the data processing is scored against the models and compared with differing parameter choices for those models. Model parameterizations that result in higher scores are stored as additional metadata for the models. This enhances connectivity for the data platform. Next, at step 360, the device control system responds to input failures or data routing failures by comparing proper input selection and routing to a data model. Among the steps this model may take includes routing to an additional information model in real-time. Next, at step 370, while performing the distributed analytics using a metadata encoded decision engine the decision engine 222 conditions, auto-updates, and trains the information models used by the devices. The model parameters may be conditioned and updated for several reasons. For example, a mismatch between the model parameters and the results of scoring the data can cause the model parameters to be updated. Additionally, model failure with regard to translating or routing the data may be a cause for changing the model parameters. Training includes a systematic search of the different parameterizations possible for the model and a comparison of the data (rescoring) with the model such that optimal, trained models can be discovered.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing distributed analytics within a distributed data processing environment, comprising:
providing the distributed data processing environment with a device control system, the device control system comprising a metadata encoded decision engine; and,
performing data input validation of information received from a plurality of devices included within the distributed data processing environment so at to improve operation of the distributed data processing environment, the distributed data processing environment being focused on predictive and reactive analysis of edge processing data.

2. The method of claim 1, further comprising:
providing predetermined responses to input failures from the plurality of devices.

3. The method of claim 2, wherein:
the input failures comprise at least one of data dropping, routing to additional models, signaling, data conditioning, and updating of model parameters.

4. The method of claim 1, wherein:
the metadata encoded decision engine comprises a metadata abstraction layer, the metadata abstraction layer facilitating translation of data requirements from an information model of the distributed data processing environment to an information model of a device of the plurality of devices.

5. The method of claim 1, further comprising:
performing distributed analytics using the metadata encoded decision engine, such distributed analytics enhancing data processing accuracy in real-time.

6. The method of claim 1, further comprising:
dynamically adapting to information models of at least some of the plurality of devices using the distributed data processing environment, the dynamically adapting comprising adapting the information models to data sources of the at least some of the plurality of devices.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing the distributed data processing environment with a device control system, the device control system comprising a metadata encoded decision engine; and,
performing data input validation of information received from a plurality of devices included within the distributed data processing environment so at to improve operation of the distributed data processing environment, the distributed data processing environment being focused on predictive and reactive analysis of edge processing data.

8. The system of claim 7, wherein the instructions executable by the processor are further configured for:
providing predetermined responses to input failures from the plurality of devices.

9. The system of claim 8, wherein:
the input failures comprise at least one of data dropping, routing to additional models, signaling, data conditioning, and updating of model parameters.

10. The system of claim 7, wherein:
the metadata encoded decision engine comprises a metadata abstraction layer, the metadata abstraction layer facilitating translation of data requirements from an information model of the distributed data processing environment to an information model of a device of the plurality of devices.

11. The system of claim 7, wherein the instructions executable by the processor are further configured for:
performing distributed analytics using the metadata encoded decision engine, such distributed analytics enhancing data processing accuracy in real-time.

12. The system of claim 7, wherein the instructions executable by the processor are further configured for:
dynamically adapting to information models of at least some of the plurality of devices using the distributed data processing environment, the dynamically adapting comprising adapting the information models to data sources of the at least some of the plurality of devices.

13. A non-transitory, computer-readable storage medium embodying computer program code, the computer program code comprising computer executable instructions configured for:
providing the distributed data processing environment with a device control system, the device control system comprising a metadata encoded decision engine; and,
performing data input validation of information received from a plurality of devices included within the distributed data processing environment so at to improve operation of the distributed data processing environment, the distributed data processing environment being focused on predictive and reactive analysis of edge processing data.

14. The non-transitory, computer-readable storage medium of claim 13, wherein the computer executable instructions are further configured for:
providing predetermined responses to input failures from the plurality of devices.

15. The non-transitory, computer-readable storage medium of claim 14, wherein:
the input failures comprise at least one of data dropping, routing to additional models, signaling, data conditioning, and updating of model parameters.

16. The non-transitory, computer-readable storage medium of claim 13, wherein:
the metadata encoded decision engine comprises a metadata abstraction layer, the metadata abstraction layer facilitating translation of data requirements from an information model of the distributed data processing environment to an information model of a device of the plurality of devices.

17. The non-transitory, computer-readable storage medium of claim 13, wherein the computer executable instructions are further configured for:
performing distributed analytics using the metadata encoded decision engine, such distributed analytics enhancing data processing accuracy in real-time.

18. The non-transitory, computer-readable storage medium of claim 13, wherein the computer executable instructions are further configured for:
dynamically adapting to information models of at least some of the plurality of devices using the distributed data processing environment, the dynamically adapting comprising adapting the information models to data sources of the at least some of the plurality of devices.
